(19) United States
(12) Patent Application Publication
(10) Pub. No.: US 2014/0066110 A1
(43) Pub. Date: Mar. 6, 2014

(54) Valet Parking System and Method

(71) Applicant: Kenneth J. Lovegreen, Lake Kiowa, TX (US)

(72) Inventor: Kenneth J. Lovegreen, Lake Kiowa, TX (US)

(73) Assignee: TEZHQ, Inc., Lake Kiowa, TX (US)

(21) Appl. No.: 14/074,944

(22) Filed: Nov. 8, 2013

Related U.S. Application Data
(63) Continuation-in-part of application No. 13/507,423, filed on Jun. 27, 2012.
(60) Provisional application No. 61/627,904, filed on Oct. 20, 2011.

(51) Int. Cl. H04W 4/14; G07G 5/00

(52) U.S. Cl. CPC H04W 4/14; G07G 5/00
USPC 455/466

(57) ABSTRACT

A method and server for controlling valet parking services without utilizing valet tickets. When a guest arrives, a valet employee sends the server a guest arrival message containing a guest identifier and an associated mobile phone identifier of the guest. The server sends a welcome message to the guest with instructions for requesting retrieval of the guest's vehicle. Communication may be by two-way text messaging or by Internet messaging. For example, the server may generate a temporary webpage for the guest and send instructions for the guest to select a link displayed on the mobile phone of the guest to request retrieval of the guest's vehicle. When the server receives the request message, the server matches the mobile phone identifier of the guest with the associated guest identifier, and sends a retrieval message to the valet employee instructing the employee to retrieve the guest vehicle with the associated guest identifier.

### CROSS-REFERENCE TO RELATED APPLICATIONS

This application is a Continuation-in-Part of co-pending U.S. patent application Ser. No. 13/507,423 filed Jun. 27, 2012, which claims the benefit of U.S. Provisional Application No. 61/627,904 filed Oct. 20, 2011, the disclosures of which are incorporated herein by reference in their entireties.

### BACKGROUND

1. Technical Field

This invention relates to valet parking services and, more particularly, to a system and corresponding method for providing valet parking services utilizing wireless text messaging or Internet-based messaging.

2. Description of Related Art

Valet services traditionally issue paper tickets, each having three detachable sections with a serial number printed on each section. When a guest drops off his car, the valet parking employee gives a first section to the guest, who retains this section for presentation to the valet parking employee upon returning to pick up his car. After parking the car, the employee places a second section of the ticket in the car, typically hung from the rearview mirror, to identify the car when being retrieved. The employee attaches a third section of the ticket to the car keys that the guest leaves with the employee upon dropping off the car so that the keys can be identified from others in the valet key bin.

When the guest returns to pick up his car, the guest presents the first ticket section to the valet parking employee. The employee matches the serial number on the first ticket section to a ticket section attached to a set of car keys in the valet key bin. The employee then takes those keys and retrieves the car having a matching serial number on the ticket section in the car.

At the end of the day, the valet company matches revenue received against the number of tickets utilized.

This process usually works well, but problems can and do occur when using paper tickets. For example, the guest may lose his ticket section. The employee may remember the guest and his car, but if not, a lengthy process may ensue to match the guest to his car and properly verify the guest as the owner of the car.

Tickets also cost the valet company money and have to be transported in sufficient numbers to each valet parking station.

Another disadvantage with paper tickets is that the guest cannot start the process of reclaiming his car until he arrives at the valet station and hands his ticket section to the valet parking employee. The guest must then wait while the employee finds the keys and retrieves the car from a remote location. With the explosion in mobile phone technology, a few vendors have developed a text-based request process that enables the guest to request his car before returning to the valet station. The valet system basically operates the same, but the guest is also given a phone number to which the guest can text a message consisting of his ticket serial number when he wants the valet parking employee to retrieve his car. The phone number is SIM-card inserted in a printer at the valet station, and when the guest sends the text message, the printer receives the message and prints out the ticket number for the employee. The employee then retrieves the guest's car in the traditional manner. In this way, the car may be waiting at the valet station when the guest physically returns.

Although enabling the guest to request the vehicle without being physically present at the valet station, this system still has a number of disadvantages. No confirmation is given to the guest, so he does not know whether he properly keyed in the phone number and the ticket serial number. If he did not, the valet printer will not receive the message or will print out the mistyped ticket number. In either case, the guest will be disappointed when he arrives at the valet station and his car is not ready for him.

Another big problem seen in the valet industry is “ticket scamming” or “re-ticketing”. This occurs when the valet employee reuses a ticket for multiple guests and pockets the money received from subsequent users of the same ticket. Since the valet company matches revenue received against the number of tickets utilized, this extra revenue is not tracked. There is currently no solution to this problem.

### SUMMARY OF THE INVENTION

It can thus be seen there is a need for a valet parking system and method that eliminates the cost and burden of paper tickets, provides convenience to the guest, and eliminates or reduces ticket scamming. The present invention provides such a system and method.

Embodiments of the present disclosure utilize a central database to check-in vehicles and tickets, and allow guests to request their vehicles without knowing a ticket serial number or a phone number for sending their request.

In one embodiment, a method in a server for controlling valet parking services is disclosed. The method includes receiving at the server, guest arrival information from a valet employee, the guest arrival information including a guest identifier assigned to a guest, and a mobile phone identifier of a mobile phone of the guest; utilizing the mobile phone identifier to send a welcoming message from the server to the mobile phone of the guest with instructions for the guest to utilize the mobile phone to request retrieval of the guest's vehicle; subsequently receiving at the server, a vehicle retrieval request message; associating the vehicle retrieval request message with the guest; and sending a retrieval instruction message from the server to the valet employee instructing the valet employee to retrieve the guest's vehicle.

In one embodiment, the method may include the server generating a temporary webpage, unique to the guest; and sending a welcoming message from the server to the mobile phone of the guest with an address for the webpage and instructions for the guest to select an Internet link on a display of the mobile phone to request retrieval of the guest's vehicle.

In another embodiment, a server for controlling valet parking services at a valet parking station is disclosed. The server includes a processor coupled to a non-transitory memory that stores computer program instructions. When the processor executes the computer program instructions, the processor causes the server to receive from a valet employee, a guest identifier assigned to a guest, and a mobile phone identifier of a mobile phone of the guest; utilize the mobile phone identifier to send a welcoming message from the server to the mobile phone of the guest with instructions for the guest to utilize the mobile phone to request retrieval of the guest's vehicle; subsequently receive at the server, a vehicle retrieval request message; associate the vehicle retrieval request message with the guest; and send a retrieval instruction message from the server to the valet employee instructing the valet employee to retrieve the guest's vehicle.

In one embodiment, the server is configured to generate a webpage for the guest; and send a welcoming message from the server to the mobile phone of the guest with an address for the webpage and instructions for the guest to select an Internet link on a display of the mobile phone to request retrieval of the guest's vehicle. When the server subsequently receives a retrieval request message from the unique webpage, the server can identify the guest, and send a retrieval message to the valet employee instructing that the guest's vehicle be retrieved.

The server may also be configured to prohibit the guest identifier from being assigned to the guest when the guest identifier has been previously assigned to another guest.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of a first exemplary embodiment of the system of the present invention, which utilizes two-way text messaging;

FIG. 2 is a flow chart illustrating the steps of a first exemplary embodiment of the method of the present invention, which utilizes two-way text messaging;

FIG. 3 is a flow chart illustrating the steps of another exemplary embodiment of the method of the present invention, which utilizes two-way text messaging;

FIG. 4 is a simplified block diagram of a first exemplary embodiment of a central server configured to perform the first embodiment of the method of the present invention;

FIG. 5 is a simplified block diagram of a second exemplary embodiment of the system of the present invention, which utilizes either two-way text messaging or Internet-based messaging;

FIG. 6 is a flow chart illustrating the steps of a second exemplary embodiment of the method of the present invention, which utilizes either two-way text messaging or Internet-based messaging;

FIG. 7 is a simplified block diagram of a second exemplary embodiment of a central server configured to perform the second embodiment of the method of the present invention; and

FIG. 8 is an illustrative drawing of a guest mobile phone showing an exemplary display screen in accordance with the present invention.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components, and circuits have not been described in detail so as not to obscure the present invention. The invention may be implemented in hardware or in a combination of hardware and software. For example, one or more computers or processors may perform the steps of the method of the present invention when executing computer program instructions stored in one or more program memories. Additionally, individual components of the invention may include their own processor and memory for controlling their functions.

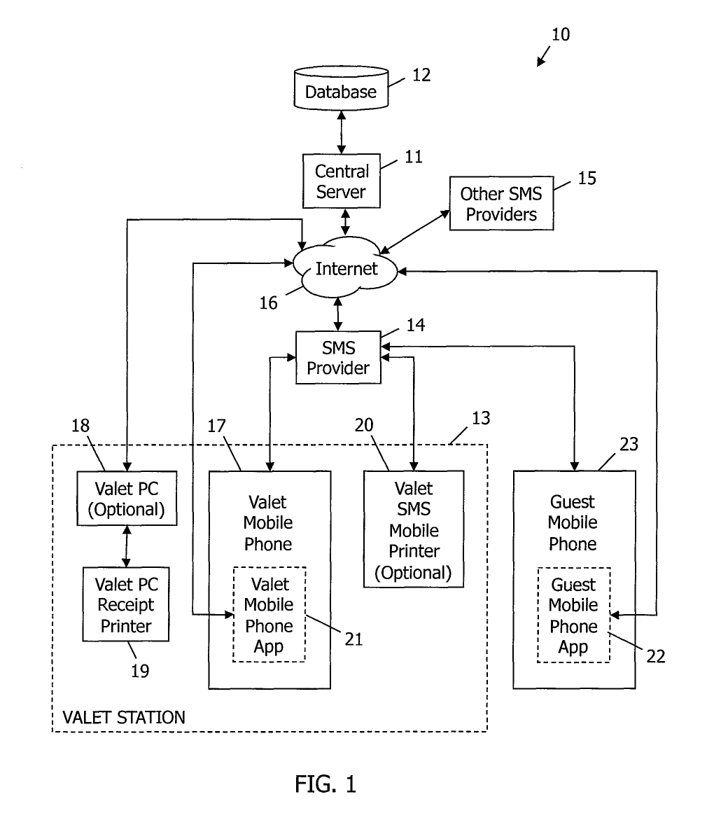

FIG. 1 is a simplified block diagram of a first exemplary embodiment of a Ticketless Valet System 10 of the present invention, which utilizes two-way text messaging. A Central Server 11 is associated with a database 12. The Central Server and database may be located remotely from one or more valet stations such as valet station 13. The Central Server may utilize a long code or an assigned Shortcode, a 5-digit telephone number for sending/receiving text messages. Shortcodes are owned by third-party Short Message System (SMS) providers such as SMS provider 14 and other SMS providers 15, whose servers may interface with the Central Server 11 over a data network such as the Internet 16. In an embodiment of the present invention, all valet systems utilize the same Shortcode.

The valet station 13 may include a valet mobile phone 17, which in one embodiment, may be a simple mobile phone with text messaging capabilities. Optionally, the valet station may also include a valet PC 18 and a valet PC receipt printer 19. Additional optional equipment may include a valet SMS mobile printer 20.

The Central Server 11 may also communicate over the Internet 16 with mobile applications (mobile apps) developed for this solution. One such application is an optional valet mobile phone application 21. Another is an optional guest mobile phone application 22 stored on a guest mobile phone 23.

### Embodiment #1

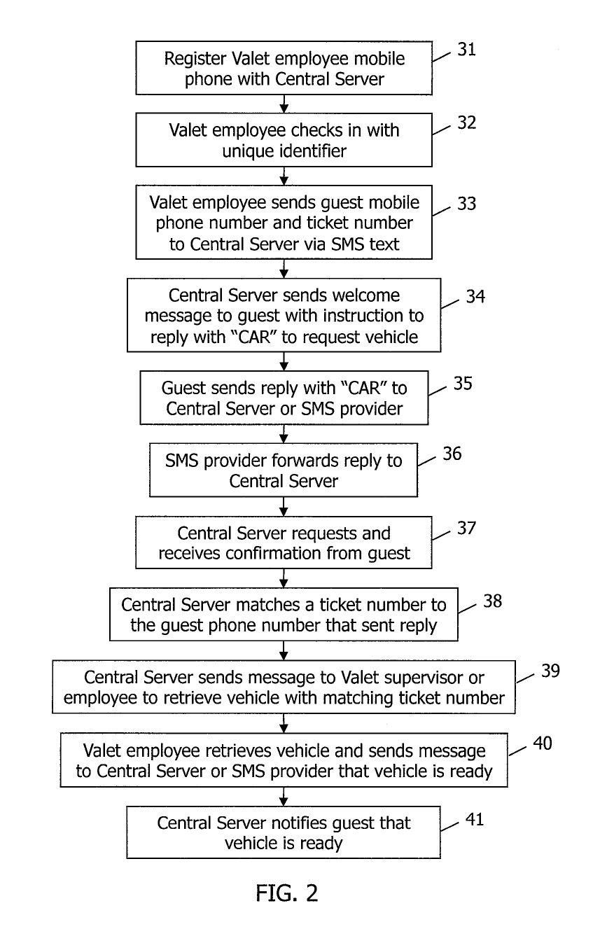

FIG. 2 is a flow chart illustrating the steps of a first exemplary embodiment of the method of the present invention, which utilizes two-way text messaging. In this embodiment, the only equipment needed at the valet station 13 is the valet mobile phone 17 (with either the valet mobile phone application 21 or text messaging capabilities) for use by the valet parking employee. It is assumed for this example that the guest has a simple mobile phone with text messaging capabilities.

At step 31, the employee's phone is registered with the Central Server 11 as belonging to the valet company. At step 32, the valet parking employee uses his/her mobile phone 17 to check in to work. The employee may do this by sending a message utilizing the valet mobile phone application 21 via the Internet, or by sending a text message such as “IN” together with a unique identifier such as a PIN number to the company's long code or Shortcode from a company mobile phone. The unique PIN number matches the employee's record in the Central Server database 12.

In one embodiment, messages get from the valet mobile phone 17 to one of the SMS providers through a serving Base Station (BS) and to a serving Mobile Switching Center (MSC) where the long code or Shortcode is recognized as belonging to a particular SMS provider, and the MSC routes the message to that carrier's SMS Message Center. For simplicity, these known network nodes are not shown in FIG. 2. The SMS Message Center then connects via a packet-switched link (wired or wireless) through the Internet 16 to the Central Server 11 and central database 12.

At step 33, upon arrival of a guest, the valet parking employee asks the guest for his/her mobile phone number. The employee sends the guest's mobile phone number along with a valet ticket number for the car as a guest arrival message to the company long code or Shortcode or to the Central Server 11 if using the valet mobile phone application 21. For example “2145551212 9876” may be sent for a phone number of 2145551212 and a ticket number of 9876. Optionally, the guest may be given a ticket, which may be paper or reusable plastic, but this is not required. In an alternative embodiment, the guest's mobile phone number itself or a portion thereof may be used as the ticket number.

Upon receiving this information, the third party server (SMS provider) passes the arrival text message to the Central Server, which matches the ticket number to the phone number for future use. The Central Server also ensures that the valet ticket number has not been previously used, thus preventing employee ticket scamming.

At step 34, the Central Server may send the guest a welcoming message (via text or the Internet and the guest mobile phone application 22) welcoming him/her to the valet company. The welcoming message may show the ticket number along with an instruction to reply to this message with “CAR” (or some other suitable word) to request their vehicle. For example the welcoming message may read, “Thanks for using ABC Valet. Please reply to this message with CAR when you wish to retrieve your vehicle.”

At a later time, when the guest desires to retrieve his/her vehicle, the guest merely replies to the welcoming message with “CAR” at step 35. The reply message, if a text message, may be sent to a long code or Shortcode, and the SMS provider passes the reply message to the Central Server 11 at step 36. At step 37, the Central Server may respond by sending back a confirmation message (to avoid mis-types, etc). For example, the confirmation message may state that the request to retrieve the guest's vehicle has been received, or may request a further confirmation from the guest. For example, the confirmation message may state, “You have requested your car. Reply Y to confirm.”

Upon confirming the proper response, the Central Server 11 looks up the phone number that sent the request and matches it to the ticket number at step 38. At step 39, the Central Server then initiates a retrieval message to the valet supervisor or the valet parking employee (via text or the Internet and the valet mobile phone application 21) to retrieve the vehicle with the matching ticket number. The retrieval message may state, for example, “Retrieve Ticket #9876”. The Central Server may also send a message to the guest stating, “Your car has been requested”. This message may optionally include a time estimate for when the car will be ready. For example, “Your car will be ready in 5 minutes.” This time period may be set to a default value such as five minutes and may be reset to a different value by the valet supervisor depending on current conditions at the valet station.

Once the car is retrieved and waiting for the guest, the valet parking employee sends a ready message such as “{Ticket Number} OK” to the Central Server 11 or SMS provider 14 at step 40. At step 41, the Central Server receives this information and may notify the guest with a message such as, “Your car is now waiting at the valet station”.

At this time or soon thereafter, the Central Server may also initiate a message to the guest requesting information for a satisfaction survey. For example, the Central Server may text, “Thanks for using ABC Valet. How was our service?” or other suitable message.

The Central Server 11 may also create a log of all of the day's activity. A valet owner can access this log to see various statistics such as the number of cars processed on given days, the number of cars currently checked in, pending requests, survey results, or other management information.

An online computer such as the valet PC 18 may also be used at the valet station 13 (if electrical power and a wired or wireless network connection are available). This enables the valet supervisor to see all cars checked in and any requests in real time.

If the valet company charges by the amount of time a car is parked, the valet (or cashier) may send a text to the Central Server such as “TT 9876” when the guest requests his car. The Central Server returns the Total Time since receiving the arrival text message so that charges can be calculated. Alternatively, the Central Server may make the calculation and return the charges to the valet station.

For those guests without mobile phones, a paper ticket can still be used.

The present invention may be implemented as either Free-to-Valet or Free-to-Guest services. A Free-to-Valet service charges the guest's mobile phone for a transaction. A Free-to-Guest service charges a monthly fee to the valet company based on the number of cars served through the system.

In one embodiment, the valet mobile phone 17 includes the valet mobile phone application 21, which provides a data service in lieu of the SMS service, while the guest mobile phone does not have the guest mobile phone application 22 and thus is limited to SMS text messaging. The valet mobile phone application may also implement a method to accept credit cards so the guest can “swipe and go”.

### Embodiment #2

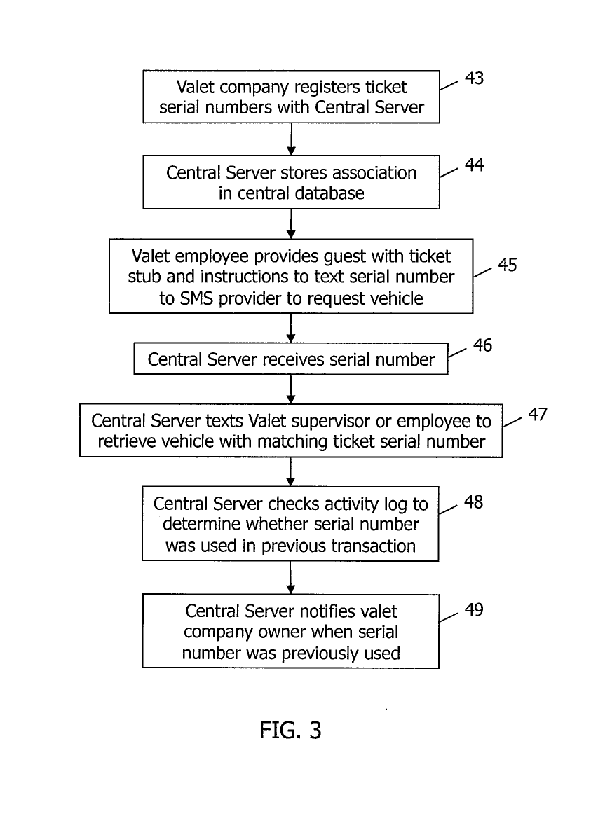

FIG. 3 is a flow chart illustrating the steps of another exemplary embodiment of the method of the present invention, which utilizes two-way text messaging. This embodiment utilizes paper tickets with serial numbers. At step 43, a valet company buys and registers the serial numbers of their valet tickets with the Central Server 11. At step 44, the Central Server stores an association between the valet company and its serial numbers in the central database 12. At step 45, the valet employee provides the guest with a ticket with a stub stating, for example, “When you want your vehicle, please text 123456789 to Shortcode UVXYZ”, where 123456789 is an exemplary serial number. The SMS provider 14 operates the same as in the first embodiment and forwards the serial number to the Central Server 11 at step 46. The Central Server looks up the serial number and knows the serial number was assigned to the associated valet company. At step 47, the Central Server then initiates a retrieval text message to the valet supervisor or the valet parking employee to retrieve the vehicle with the matching ticket serial number. At step 48, the Central Server may also check the activity log to determine whether the serial number has already been used in a previous transaction. If so, the Central Server may flag the transaction as a duplicate and at step 49 may notify the valet company owner of a possible ticket-scamming event by an employee.

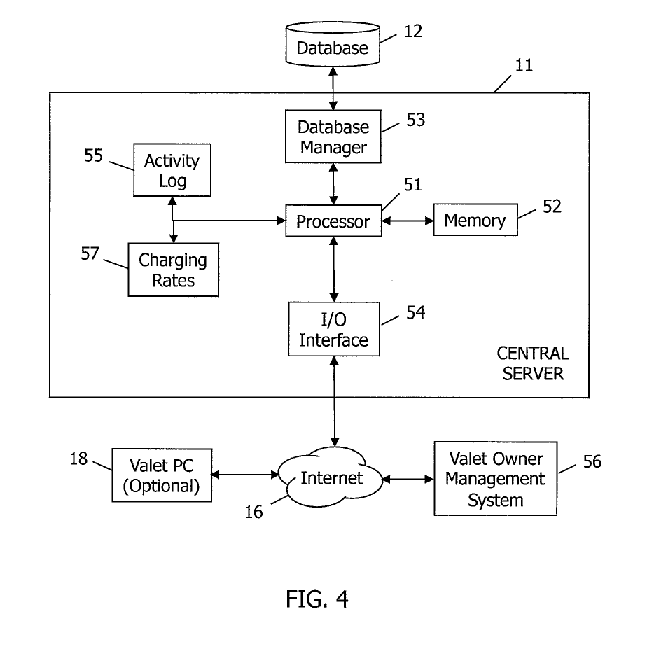

FIG. 4 is a simplified block diagram of a Central Server 11 configured to perform the first embodiment of the method of the present invention. Operation of the Central Server may be controlled by hardware or a combination of hardware and software. In the illustrated embodiment, operation of the Central Server is controlled by a processor 51 executing computer program instructions stored on a non-transitory memory 52. The processor controls a database manager 53 to read and write information to the database 12. The processor also controls an input/output (I/O) interface 54, which enables the Central Server to communicate over the Internet 16 with equipment at valet stations and with mobile phone applications.

The processor 51 may also log and timestamp each of the day's transactions in an activity log 55. Through a valet owner management system 56, a valet owner can access the activity log to see various statistics such as the number of cars processed on given days, the number of cars currently checked in, pending requests, survey results, or other management information. The processor also accesses the activity log when checking for ticket-scamming transactions to determine whether a given serial number has already been used in a previous transaction. If so, the Central Server may flag the transaction as a duplicate and notify the valet company owner of a possible ticket scamming event through the valet owner management system.

As noted above, if the valet company charges by the amount of time a car is parked, the valet (or cashier) may send a text to the Central Server such as “TT 9876” when the guest requests his car. The Central Server 11 checks the activity log 55, and returns the Total Time since receiving the arrival text message so that charges can be calculated. Alternatively, the Central Server may also access a charging rates table 57 and make the calculation and return the charges to the valet station.

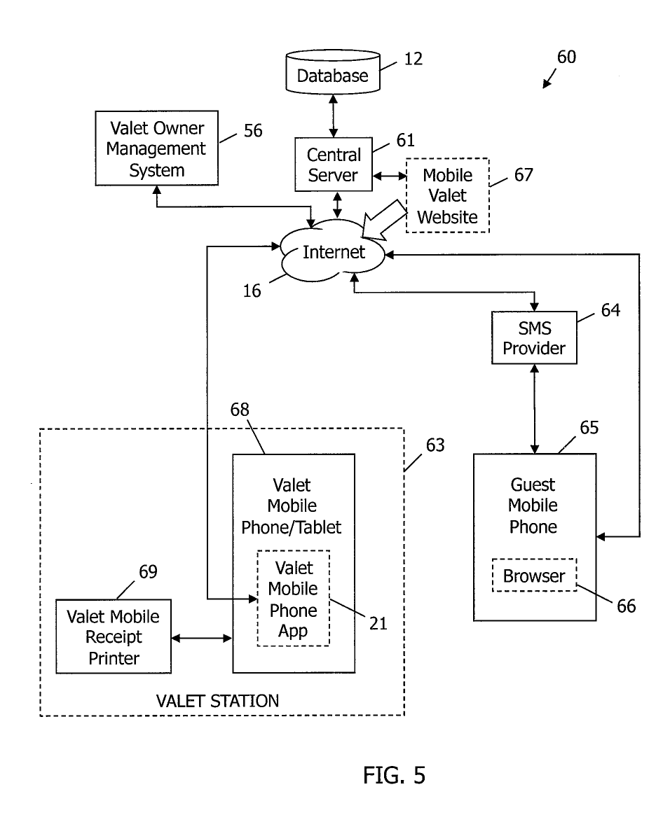

In some countries, the two-way text messaging utilized in the first embodiment described above is not possible because incoming texts are blocked or filtered. For example, the Caller ID phone number may appear on the screen as “SMSInfo” or the like, and users cannot reply to an alphanumeric phone number. One solution to this problem is for the valet company to install SMS modems locally in the country where the valet service is being offered. The Central Server would communicate with a local server/modem to send and receive text messages from SIM cards installed in the modems. Another solution utilizing Internet-based messaging is shown in FIGS. 5-8 below.

FIG. 5 is a simplified block diagram of a second exemplary embodiment of the Ticketless Valet System 60 of the present invention, which utilizes either two-way text messaging or Internet-based messaging. A Central Server 61 is associated with a database 12. The Central Server and database may be located remotely from one or more valet stations such as valet station 63. The Central Server may interface with the valet station over a data network such as the Internet 16. The Central Server may also interface through the Internet with the valet owner management system 56, an SMS provider 64 for sending and receiving text messages with a guest mobile phone 65, and/or directly with the guest mobile phone. The guest mobile phone may include a browser 66 enabling the guest mobile phone to access a mobile valet website 67 providing Internet-based valet communication services. The mobile valet website may be generated by the Central Server or by a separate application server (not shown).

The Central Server 61 and the guest mobile phone 65 may communicate through the Internet using any suitable form of electronic communications enabling the guest to receive a welcome message and to request retrieval of his vehicle when desired. For example, the communications may be through texts, e-mails, web browsing, social networks, and the like.

The valet station 63 may include a valet mobile phone or tablet computer 68, which in one embodiment may include the valet mobile phone application 21 for communicating with the Central Server 61 through the Internet 16. Optionally, the valet station may also include a valet mobile receipt printer 69 in wired or wireless communication with the valet mobile phone/tablet.

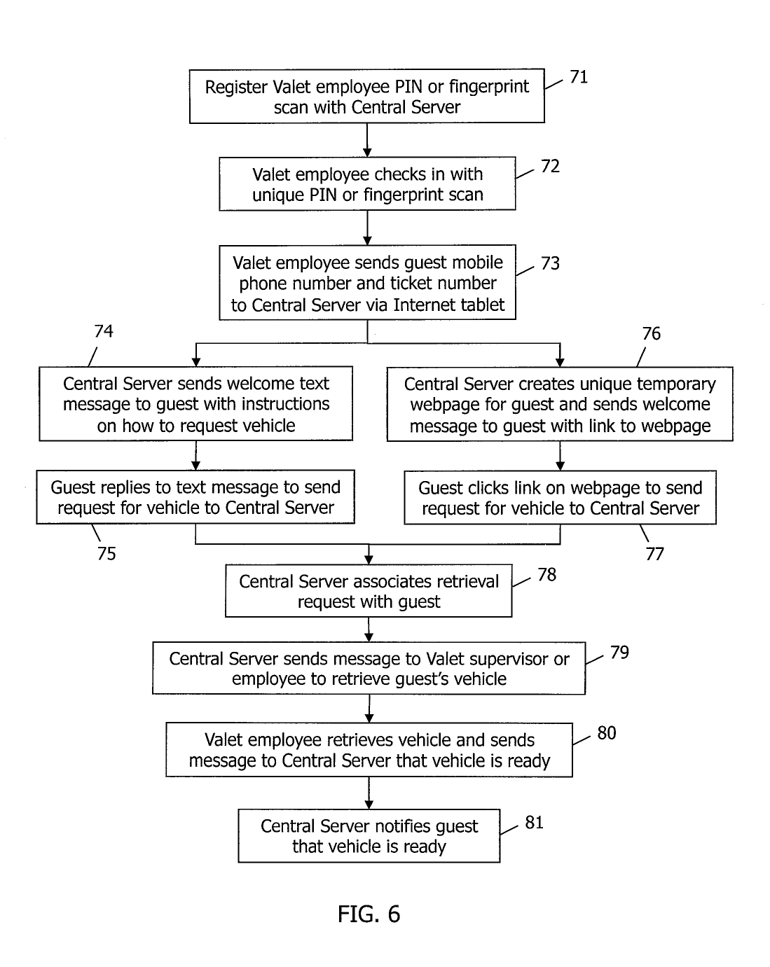

FIG. 6 is a flow chart illustrating the steps of a second exemplary embodiment of the method of the present invention, which utilizes either two-way text messaging or Internet-based messaging. At step 71, a unique identifier of the Valet employee is registered with the Central Server 61. The identifier may be, for example, a Personal Identification Number (PIN) or a biometric scan such as a fingerprint scan. At step 72, the Valet employee checks in with the unique PIN or fingerprint scan. At step 73, after greeting a new guest, the Valet employee sends the guest's mobile phone number and ticket number to the Central Server. The employee may use, for example, an Internet-capable tablet computer or smart phone for this purpose.

There are two optional ways for the Central Server 61 to provide the guest with the ability to request his vehicle. In a first option shown in steps 74 and 75, the Central Server may send a text welcome message to the guest with instructions on how to request his vehicle. At step 75, the guest replies to the text message to send a request for his vehicle to the Central Server. In a second option shown in steps 76 and 77, the Central Server or an application server may calculate a unique webpage for the guest and may send a welcome message to the guest with a link to the webpage. At step 77, the guest clicks a link on the webpage to send a request for his vehicle to the Central Server. This option enables the guest to communicate back and forth with the Central Server via the Internet rather than texting. Since the webpage is unique to the guest, the server can associate any communications from the webpage with the guest.

At step 78, the Central Server 61 associates the request with the guest. At step 79, the Central Server sends a message to the Valet supervisor or employee to retrieve the guest's vehicle. At step 80, the Valet employee retrieves the guest's vehicle and sends a message to the Central Server indicating that the vehicle is ready. At step 81, the Central Server notifies the guest that his vehicle is ready.

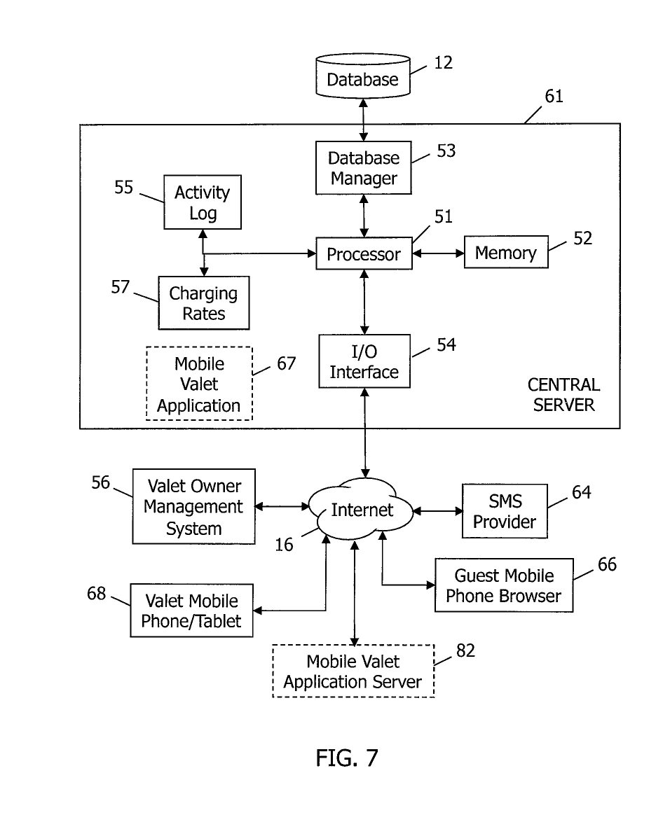

FIG. 7 is a simplified block diagram of a second exemplary embodiment of a Central Server 61 configured to perform the second embodiment of the method of the present invention. The Central Server in this embodiment is similar to the Central Server 11 of the first embodiment, except that it interfaces through the Internet with the browser 66 in the guest's mobile phone to provide Internet-based communications. The mobile valet application 67 may be executed by the Central Server or may optionally be executed by a separate mobile valet application server 82.

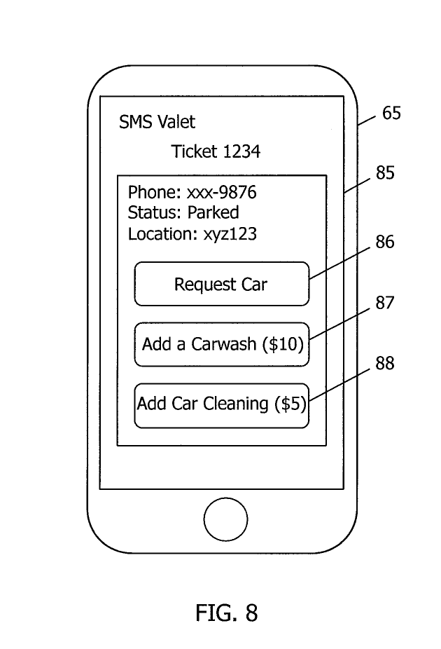

FIG. 8 is an illustrative drawing of a guest mobile phone 65 showing an exemplary display screen in accordance with the present invention. When the browser 66 navigates to the mobile valet application 67, a temporary webpage 85 is displayed on the guest mobile phone. The webpage is unique to the guest. On the webpage is a link 86 that the guest clicks to request his vehicle. Additional links 87 and 88 may be included to offer other features and services provided by the valet company and that may be of interest to the guest. The server may remove the temporary webpage following a period of time after the guest requests his vehicle.

In another embodiment, the system may offer location-based advertising. Since the exact location of the guest is known when they check-in, the Central Server 11 may send appropriate advertising texts to the guest for retailers in the area. For example, if the guest checks in at a mall, the system may send, in addition to the welcome message, but also text coupon(s) for nearby stores.

It is thus believed that the operation and construction of the present invention will be apparent from the foregoing description. While the system and apparatus shown and described has been characterized as being preferred, it will be readily apparent that various changes and modifications could be made therein without departing from the scope of the invention as defined in the following claims.

What is claimed is:

1. A method in a server for ticketless control of valet parking services, the method comprising the steps of:
receiving from a valet employee, a guest identifier assigned to a guest, and a mobile phone identifier of a mobile phone of the guest;
utilizing the mobile phone identifier to send a welcoming message from the server to the mobile phone of the guest with instructions for the guest to utilize the mobile phone to request retrieval of the guest's vehicle;
subsequently receiving at the server, a vehicle retrieval request message;
associating the vehicle retrieval request message with the guest; and
sending a retrieval instruction message from the server to the valet employee instructing the valet employee to retrieve the guest's vehicle.

2. The method according to claim 1, wherein the step of receiving the guest identifier and the mobile phone identifier includes receiving the guest identifier and the mobile phone identifier from the valet employee via an Internet-capable computer and the Internet.

3. The method according to claim 1, wherein the mobile phone identifier is an Internet Protocol (IP) address of the mobile phone of the guest, and the step of sending the welcoming message from the server to the mobile phone of the guest includes:
generating a webpage for the guest;
sending an address for the webpage to the guest's mobile phone via the Internet; and
instructing the guest to navigate to the webpage and select an Internet link on a display of the mobile phone to request retrieval of the guest's vehicle.

4. The method according to claim 3, wherein a browser in the mobile phone of the guest navigates to the webpage address and presents the webpage on the display of the mobile phone, wherein the webpage is a temporary webpage, unique to the guest.

5. The method according to claim 4, wherein the temporary webpage includes the Internet link for requesting retrieval of the guest's vehicle, and the server associates the vehicle retrieval request message with the guest by noting that the vehicle retrieval request message came from the temporary webpage, unique to the guest.

6. The method according to claim 5, wherein the temporary webpage also includes at least one additional Internet link for requesting other services.

7. The method according to claim 1, wherein the mobile phone identifier is a directory number of the mobile phone of the guest, and the step of sending the welcoming message from the server to the mobile phone of the guest includes sending a Short Message Service (SMS) text message from the server to the directory number of the mobile phone of the guest.

8. The method according to claim 1, further comprising the steps of:
receiving at the server, a ready message from the valet employee indicating that the guest's vehicle has been retrieved; and
sending a notification message from the server to the mobile phone of the guest indicating that the guest's vehicle has been retrieved.

9. The method according to claim 8, wherein:
the step of receiving the ready message includes receiving the ready message from the valet employee via the Internet-capable computer and the Internet; and
the step of sending the notification message includes one of:
sending the notification message to the IP address of the mobile phone of the guest via the Internet; and
sending the notification message as an SMS text message to the directory number of the mobile phone of the guest.

10. The method according to claim 1, further comprising prohibiting the guest identifier from being assigned to the guest when the guest identifier has been previously assigned to another guest.

11. A server for controlling valet parking services at a valet parking station, wherein the server includes a processor coupled to a non-transitory memory that stores computer program instructions, wherein when the processor executes the computer program instructions, the processor causes the server to:
receive from a valet employee, a guest identifier assigned to a guest, and a mobile phone identifier of a mobile phone of the guest;
utilize the mobile phone identifier to send a welcoming message from the server to the mobile phone of the guest with instructions for the guest to utilize the mobile phone to request retrieval of the guest's vehicle;
subsequently receive at the server, a vehicle retrieval request message;
associate the vehicle retrieval request message with the guest; and
send a retrieval instruction message from the server to the valet employee instructing the valet employee to retrieve the guest's vehicle.

12. The server according to claim 11, wherein the server is configured to receive the guest identifier and the mobile phone identifier from the valet employee via an Internet-capable computer and the Internet.

13. The server according to claim 11, wherein the mobile phone identifier is an Internet Protocol (IP) address of the mobile phone of the guest, and the server is configured to send the welcoming message from the server to the mobile phone of the guest by:
generating a webpage for the guest;
sending an address for the webpage to the guest's mobile phone via the Internet; and
instructing the guest to navigate to the webpage and select an Internet link on a display of the mobile phone to request retrieval of the guest's vehicle.

14. The server according to claim 13, wherein the server is configured to generate the webpage as a temporary webpage, unique to the guest, and a browser in the mobile phone of the guest navigates to the webpage address and presents the temporary webpage on the display of the mobile phone.

15. The server according to claim 14, wherein the temporary webpage includes the Internet link for requesting retrieval of the guest's vehicle, and the server associates the vehicle retrieval request message with the guest by noting that the vehicle retrieval request message came from the temporary webpage, unique to the guest.

16. The server according to claim 15, wherein the temporary webpage also includes at least one additional Internet link for requesting other services.

17. The server according to claim 11, wherein the mobile phone identifier is a directory number of the mobile phone of the guest, and the server is configured to send the welcoming message from the server to the mobile phone of the guest by sending a Short Message Service (SMS) text message from the server to the directory number of the mobile phone of the guest.

18. The server according to claim 11, wherein the server is further configured to:
receive at the server, a ready message from the valet employee indicating that the guest's vehicle has been retrieved; and
send a notification message from the server to the mobile phone of the guest indicating that the guest's vehicle has been retrieved.

19. The server according to claim 18, wherein the server is configured to:
receive the ready message from the valet employee via the Internet-capable computer and the Internet; and
send the notification message to the IP address of the mobile phone of the guest via the Internet, or send the notification message as an SMS text message to the directory number of the mobile phone of the guest.

20. The server according to claim 11, wherein the server is further configured to prohibit the guest identifier from being assigned to the guest when the guest identifier has been previously assigned to another guest.
